(19) United States
(12) Patent Application Publication
(10) Pub. No.: US 2011/0291399 A1
(43) Pub. Date: Dec. 1, 2011

(54) SECURITY FOIL OR SECURITY LABEL COMPRISING A MANIPULATION DETECTION SYSTEM

(76) Inventor: Marco Mayrhofer, Sierning (AT)

(21) Appl. No.: 13/139,596

(22) PCT Filed: Mar. 5, 2010
(86) PCT No.: PCT/EP2010/001373

§ 371 Date: Aug. 4, 2011

(30) Foreign Application Priority Data
Mar. 9, 2009 (AT) A 373/2009

(51) Int. Cl. B42D 15/00

(52) U.S. Cl. 283/72

(57) ABSTRACT

The invention relates to a security foil consisting of two or more carrier substrates which have at least one optically active structure and at least two metal layers, wherein the security foil is composed as follows: a) a first carrier substrate, b) a first radiation-curable paint layer into which an optically active structure is incorporated, c) a first metal layer, d) a protective paint layer, e) an adhesive layer, f) a second carrier substrate, g) a second radiation-curable paint layer, h) a second metal layer, i) optionally a protective paint layer, and k) optionally an adhesive coating, and wherein the adhesion between the layers g) and h) or f) and g) is significantly lower than the adhesion between the remaining layers.

The invention relates to a security foil which can be applied to a valuable document or to a data storage medium and permits manipulation to be detected.

Security labels or security foils are known and generally have a manipulation detection layer, which means a layer having different adhesive regions, and an adhesive coating and additionally one or more security features. Particularly suitable security features are, for example, luminescent security features, which can generally be produced cost-effectively but provide relatively good protection against imitation.

The object of the invention was to provide a security foil which can be applied to an object to be secured, for example a valuable document, a data storage medium, a package or the like.

The subject of the invention is therefore a security foil comprising two or more carrier substrates which have at least one optically active structure and at least two metallic layers, characterized in that the security foil is built up as follows:

a) a first carrier substrate

b) a first radiation-curable paint layer, into which an optically active structure is introduced

c) a first metallic layer

d) if appropriate, a protective paint layer

e) an adhesive layer

f) a second carrier substrate

g) a second radiation-curable paint layer

h) a second metallic layer

i) if appropriate, a protective paint layer

k) if appropriate, an adhesive coating,

wherein the adhesion between the layers g) and h) or f) and g) is significantly lower than the adhesion between the remaining layers.

Suitable carrier substrates a) are, for example, carrier foils, preferably flexible plastic films, for example made of Pi, PP, MOPP, PE, PPS, PEEK, PEK, PEI, PSU, PAEK, LCP, PEN, PBT, PET, PA, PC, COC, POM, ABS, PVC, fluoropolymers such as Teflon and the like. The carrier foils preferably have a thickness from 5-700 μm, preferably 5-200 μm, particularly preferably 5-100 μm.

Here, optically active structure is understood to mean in particular optically diffractive active structures, such as holograms, surface reliefs, diffractive structures, diffraction gratings, kinegrams and the like.

A radiation-curable paint layer b) is applied to the first carrier substrate.

The radiation-curable paint can be, for example, a radiation-curable paint system based on a polyester, an epoxy or polyurethane system which contains two or more different photo-initiators familiar to those skilled in the art, which are able to initiate curing of the paint system to a different extent at different wavelengths. For instance, a photo-initiator can be activated at a wavelength of 200 to 400 nm, the second photo-initiator can then be activated at a wavelength of 370 to 600 nm. A sufficient difference should be maintained between the activation wavelengths of the two photo-initiators that excessively high excitation of the second photo-initiator does not take place while the first photo-initiator is being activated. The range in which the second photo-initiator is excited should lie in the transmission wavelength range of the carrier substrate used.

For the main curing (activation of the second photo-initiator), electron radiation can also be used.

The radiation-curable paint used can also be a water-dilutable paint. Paint systems based on polyesters are preferred.

The replication of the surface structure, i.e. the diffraction or relief structure into the radiation-curable paint layer, is carried out for example at a controlled temperature by means of a die or by using an embossing mold, said paint layer having been pre-cured as far as the gel point by activating the first photo-initiator and being at this stage at the time of the replication.

If use is made of a water-dilutable radiation-curable paint, pre-drying, for example by means of IR radiators, can be connected upstream if appropriate.

The layer thickness of the radiation-curable paint applied can vary, depending on the requirement on the end product and the thickness of the substrate and is generally between 0.5 and 50 μm, preferably between 2 and 10 μm, particularly preferably between 2 and 5 μm.

A full-area or preferably partial metallic layer c) is subsequently applied to the optically active structure produced in this way.

To this end, preferably in a first step, a color coating soluble in a solvent is applied, in a second step, this layer is treated by means of an in-line, plasma, corona or flame process and, in a third step, a layer of metals, metal compounds, alloys is applied, whereupon, in a fourth step, the color coating is removed by means of a solvent, if appropriate combined with mechanical action.

The color coating used or paint coating used is soluble in a solvent, preferably in water, but it is also possible for a color coating soluble in any desired solvent, for example in alcohol, esters and the like, to be used. The color coating or paint coating can be conventional formulations based on natural or artificial macromolecules. The soluble color coating can be pigmented or non-pigmented. It is possible to use all known pigments as the pigment. Particularly suitable are TiO₂, ZnS, kaolin and the like.

The printed carrier substrate is then treated by means of an in-line, plasma (low-pressure or atmospheric plasma), corona or flame process if appropriate in order to improve the adhesion of the layer subsequently applied. By means of a high-energy plasma, for example an Ar or Ar/O₂ plasma, the surface is cleaned of toning residues of the printing inks. At the same time, the surface is activated. In the process, terminal polar groups are produced on the surface. As a result, the adhesion of metals and the like to the surface is improved.

If necessary, at the same time as the application of the plasma, corona or flame treatment, a thin metal or metal oxide layer can be applied as an adhesion promoter, for example by means of sputtering or vapor deposition. Particularly suitable here are Cr, Al, Ag, Ti, Cu, TiO₂, Si oxides or chromium oxides. This adhesion promoter layer generally has a thickness of 0.1 nm-5 nm, preferably 0.2 nm-2 nm, particularly preferably 0.2 to 1 nm.

As a result, the necessary excellent adhesion between the two layers b) and c) is achieved.

A partial metallic layer c) can be applied in the same way as the second metallic layer h) in the form of letters, numbers, symbols, lines, guilloches, logos and the like. Furthermore, these letters, numbers, symbols, lines, guilloches, logos and the like can be defined by cutouts in the metallic layer.

Suitable metallic layers are, for example, layers of Al, Cu, Au, Ag, Pd, Pt, Ni, Zn, Sn and the like. Furthermore, alloys or metallic oxides such as copper oxides, TiO₂, SiOx are suitable as metallic layers.

The structure is then provided with a protective paint layer, if appropriate, and, by using a laminating adhesive layer, is joined to a further carrier substrate f), which likewise has a radiation-curable paint layer g).

In order to achieve a high degree of adhesion between this second carrier substrate f) and the second radiation-curable paint layer g), an acrylate-coated plastic film or a foil provided with an adhesion promoter is preferably used, so that the adhesion of the radiation-curable paint to the foil is considerably better than to the metallization.

If the lowest adhesion in the structure is to be established between the layers f) and g), then the materials listed for the carrier substrate a) are suitable for the carrier substrate f).

This second radiation-curable paint layer can have a further optically active structure.

If appropriate, the radiation-curable paint layer can be provided with a further coating, for example a partial opaque coating, which has cutouts in the form of characters, letters, patterns, symbols, lines, guilloches and the like.

A further partial metallic layer h) is then applied to this layer, but during the production of the layer the above-described steps of pre-treatment and of application of an adhesion promoter not being carried out if the lowest adhesion in the structure is to be present between the layers g) and h).

As a result, weaker adhesion of the metallic layer to the layer lying underneath is achieved; here, a weakening is produced in the composite, which is known as an intended fracture point.

The function of the security element is based on two metallizations which are superimposed in such a way that only the upper metallization (having the first optically active structure) is visible and only after manipulation does the second metallization (possibly having a further optically active structure) appear.

Partial metallic layers c) and g) are preferably congruent but can also be arranged partially overlapping in relation to one other or partly complementing one other, so that before the manipulation the impression of a continuous metallization is produced. The layers can be congruent with the optically active structure(s) or else can be arranged partially overlapping.

The structure can then be provided with a protective paint layer and/or an adhesive coating for application to a substrate.

The adhesive coating can be a self-adhesive coating, a cold-seal or hot-seal coating.

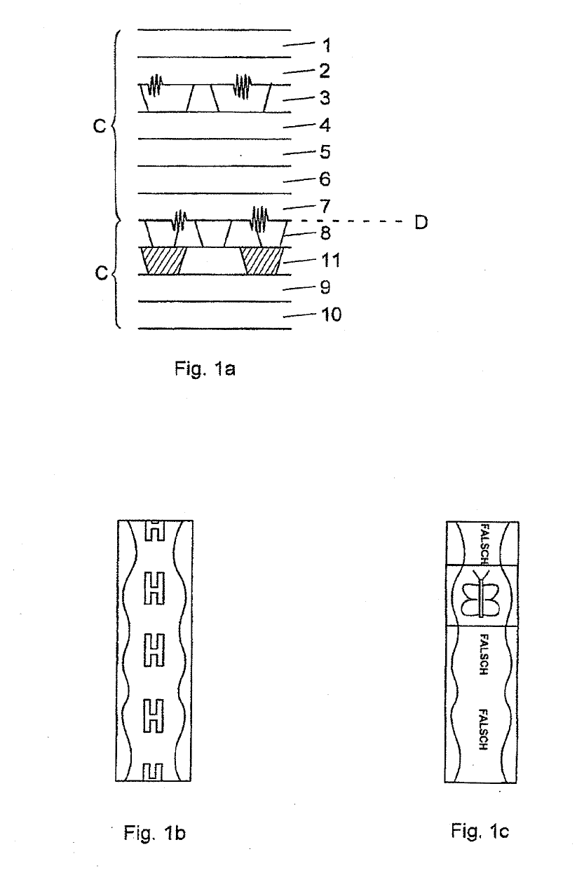

In one embodiment (FIG. 1), the two metalized regions are identical and superimposed in exact register. Furthermore, between the first and second metallization there is hidden embossing, which becomes visible only after manipulation. On the substrate, the lower metallization having the hologram “FALSE” (German “FALSCH”) is left behind. The first hologram is pulled off.

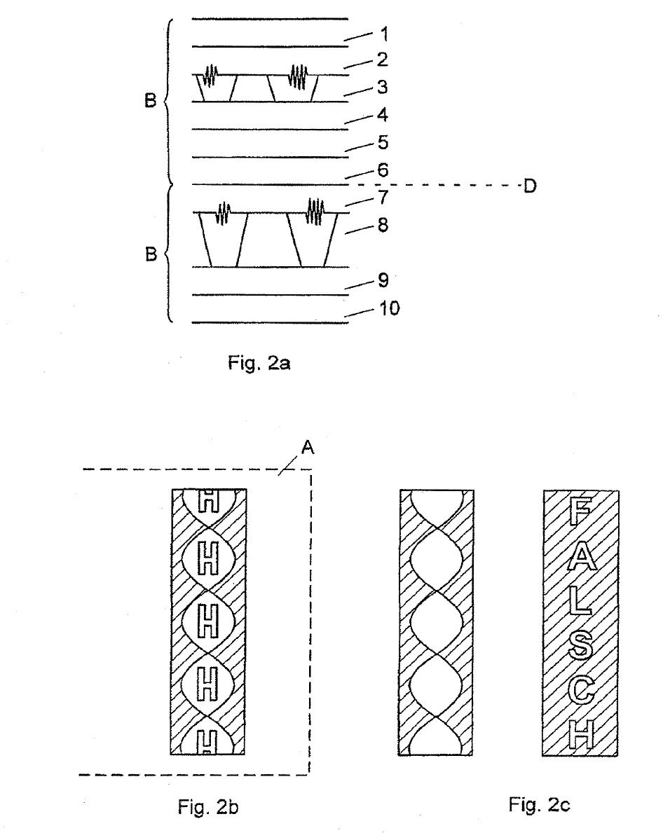

In a further embodiment (FIG. 2), a further partial layer (e.g. in the form of letters or defining the letters as cutouts) is hidden under the first partial metallic layer c) (including embossing) and becomes visible only when manipulation is carried out. After the layer has been pulled off, metalized letters “FALSE” are left behind on the substrate. The main hologram is pulled off.

If optically active structures are introduced into the layers b) and g), respectively, then these can be introduced in accurate register with one another or at least partly overlapping.

The optically active structure can, if appropriate, contain additional information, so that proof of authenticity is also possible after the manipulation. The additional information introduced can be, for example, product codes, batch numbers and the like.

Furthermore, the security foil according to the invention can have further security features, such as electrically conductive layers, layers with magnetic or optical features (for example luminescent features, thermochromic features, pearlescent layers and the like).

In the figures
A means the data storage medium or the package to be secured
B and C the alternative regions of high adhesion
D the intended fracture point
1 a first carrier substrate
2 a first radiation-curable paint layer, into which an optically active structure is introduced,
3 a first (partial) metallic layer
4 a protective paint layer
5 an adhesive layer
6 a second carrier substrate
7 a second radiation-curable paint layer
8 a second (partial) metallic layer
9 a protective paint layer
10 an adhesive coating
11 a partial opaque layer

The security foil according to the invention can be used as a security element on data storage media or packages, as a security label for securing objects or packages or as a vignette.

1. A security foil comprising two or more carrier substrates which have at least one optically active structure and at least two metallic layers, characterized in that the security foil is built up as follows:
a) a first carrier substrate
b) a first radiation-curable paint layer, into which an optically active structure is introduced
c) a first metallic layer
d) a protective paint layer
e) an adhesive layer
f) a second carrier substrate
g) a second radiation-curable paint layer
h) a second metallic layer
i) if appropriate, a protective paint layer
k) if appropriate, an adhesive coating,
wherein the adhesion between the layers g) and h) or f) and g) is significantly lower than the adhesion between the remaining layers.

2. The security foil as claimed in claim 1, characterized in that the layer g) has an optically active structure.

3. The security foil as claimed in claim 1, characterized in that the optically active structure is a hologram, a surface relief, a diffractive structure, a diffraction grating or a kinegram.

4. The security foil as claimed in claim 1, characterized in that a further partial opaque layer is present between layer g) and h).

5. The security foil as claimed in claim 1, characterized in that the layers c) and h) are full-area or partial layers.

6. The security foil as claimed in claim 5, characterized in that the partial layers c) and h) are arranged to cover one another in accurate register or at least partially overlapping in relation to one another and/or in relation to the optically active structure(s).

7. The security foil as claimed in claim 1, characterized in that the optically active structures introduced into the layers b) and g) are introduced in accurate register with one another or at least partly overlapping.

8. The security foil as claimed in claim 1, characterized in that the security foil has further full-area or partial layers with electrically conductive, magnetic or optical features.

9. The security foil as claimed in claim 1, characterized in that, for the case in which adhesion between the layers f) and g) is substantially lower than the adhesion between the remaining layers, the second carrier substrate f) used is a plastic film made of PI, PP, MOPP, PE, PPS, PEEK, PEK, PEI, PSU, PAEK, LCP, PEN, PBT, PET, PA, PC, COC, POM, ABS, PVC, fluoropolymers such as Teflon.

10. The security foil as claimed in claim 1, characterized in that, for the case in which adhesion between the layers g) and h) is substantially lower than the adhesion between the remaining layers, the second carrier substrate f) used is an acrylate-coated plastic film or a foil provided with an adhesion promoter.

11. The use of the security foil as claimed in claim 1 as a security element on data storage media or packages, as a security label for securing objects or packages or as a vignette.
